(19) United States
(12) Patent Application Publication
(10) Pub. No.: US 2001/0009881 A1
(43) Pub. Date: Jul. 26, 2001

(54) Control system for a transmission

(76) Inventors: Heinz-Hagen Albs, Hildesheim (DE); Stefan Klik, Hannover (DE); Peter Homann, Neustadt (DE); Holger Thies, Wunstorf (DE); Alfred Klatt, Wathlingen (DE)

Correspondence Address: Proskauer Rose LLP, Patent Dept., 1585 Broadway, NewYork, NY, 10036, US

(21) Appl. No.: 09/756,963

(22) Filed: Jan. 9, 2001

(30) Foreign Application Priority Data
Jan. 22, 2000 (DE) 100 02 693.1

(51) Int. Cl. F16H 63/02

(52) U.S. Cl. 475/127; 475/128

(57) ABSTRACT

A transmission control system consists essentially of two actuating cylinders, a pressure supply system, a controllable valve system for connecting the actuating cylinders to the pressure supply system, and an electrical control system for actuating the controllable valve system. In order to create a compact control system unit, the controllable valve system, at least part of the pressure supply system, and the electrical control system are all combined into a single integrated component. Alternatively, the actuating cylinders may also be included within the single component.

### FIELD OF THE INVENTION

The present invention relates to a control system for a transmission, e.g., an automotive transmission. More specifically, the present invention relates to a compact, integrated control system, which is readily adaptable to any transmission.

### BACKGROUND OF THE INVENTION

A typical transmission control system, as is known in the art, e.g., German patent application DE 196 37 001, includes several actuating cylinders, a motor-driven hydraulic pump, a tank for a hydraulic medium and, if necessary, a reservoir for the hydraulic medium under pressure. Such a system also includes a valve system, in the form of a proportional regulating valve, which is used to control the actuating cylinders, and an electrical control system, which is used to actuate the valve system. The hydraulic pump, motor, valve system, and, if applicable, the reservoir/tank, are combined into one component. This component serves as a hydraulic unit, which is structurally separate from the actuating cylinders and electrical control system, and is located in the proximity of the transmission to be controlled.

It is an object of the present invention to improve the aforementioned type of control system by providing an integrated, compact control component, consisting of at least part of a pressure supply system, a controllable valve system, and an electrical control system. In addition, the inventive component would be easy to assemble, and readily adaptable to any transmission.

It is a further object of the present invention to provide an alternative embodiment, which encompasses the actuating cylinders, in addition to the above described systems, within a single integrated control component. This embodiment has the further advantage of easy installation on a transmission.

As a result of integrating into a single component the controllable valve system, the pressure supply system and the electrical control system of the first embodiment, or with the additional integration into a single component of the actuating cylinders of the second embodiment, both the pressure medium connections and the electrical connections are kept short. In addition, the electrical connections and the pressure medium connections are located, at least in part, within the housing of the component. As such, potential damage to these connections from outside influences, which could interfere with the proper functioning of the transmission control system, is minimized.

In an advantageous further development of the present invention, the controllable valve system can be actuated by electromagnetic means.

### SUMMARY OF THE INVENTION

In accordance with an illustrative embodiment of the present invention, a control system component for a transmission is made up of:

a. a pressure supply system, including a motor-driven pump, a tank to hold the pressure medium, a reservoir to hold the pressure medium under pressure, and a pressure regulator;

b. an actuating cylinder unit,

c. a controllable valve system, which contains electrically controlled solenoid valves for connecting the actuating cylinder unit to the pressure supply system;

d. an electrical control system, which actuates and controls the controllable valve system;

e. a combination housing unit, which contains at least part of the pressure supply system, the controllable valve system, and the electrical control system, within a single control system component.

In an alternative embodiment, the actuating cylinder unit is also contained within a combination housing unit, in addition to the pressure supply system, the controllable valve system, and the electrical control system.

Illustrative embodiments of the present invention are more fully described below in conjunction with the following drawings.

### BRIEF DESCRIPTION OF THE DRAWINGS

FIG. 1 schematically depicts an embodiment which includes an actuating cylinder unit, a pressure supply system, a controllable valve system, and an electrical control system.

FIG. 2 illustrates the integrated inventive component, consisting of the pressure supply system, the controllable valve system, and the electrical control system, within a combination housing unit.

FIG. 3 illustrates an alternative embodiment, which includes the pressure supply system, the controllable valve system, the electrical control system, and the actuating cylinder unit within a combination housing unit.

### DETAILED DESCRIPTION OF THE INVENTION

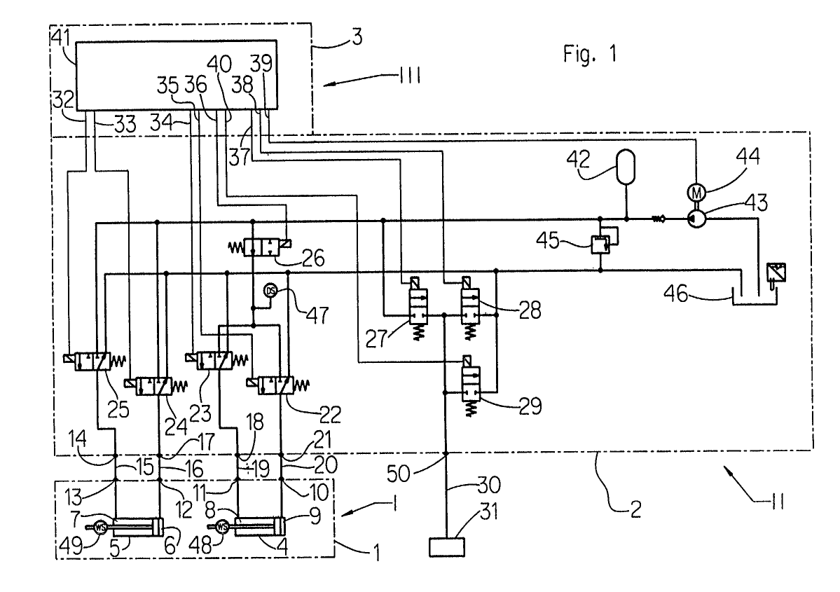

FIG. 1 shows an embodiment of the present invention which can be used to control a transmission and clutch. The major components of the control system include an actuating cylinder unit I, consisting of two actuating cylinders 4,5 for the transmission, a coupling cylinder 31, and an additional component II,III, consisting of a hydraulic unit II and an electric control system III.

A first actuating cylinder 4 and a second actuating cylinder 5 are combined into one actuating cylinder unit I, such that two cylinder bores are provided in one common housing 1 for both actuating cylinders 4 and 5. As such, a piston is installed in each cylinder bore, which can move in the direction of its longitudinal axis. A first pressure medium chamber 9 of first actuating cylinder 4 is connected to a first pressure medium connection 10, located on housing 1, and a second pressure medium chamber 8 of first actuating cylinder 4 is connected to a second pressure medium connection 11, located on housing 1. A first pressure medium chamber 6 of second actuating cylinder 5 is connected to a third pressure medium connection 12, located on housing 1, and a second pressure medium chamber 7 of second actuating cylinder 5 is connected to a fourth pressure medium connection 13, located on housing 1.

A hydraulic unit II, consisting of a pressure supply system 43, 44, 42, 45, 46, and of a controllable valve system 22, 23, 24, 25, 26, 27, 28, 29, for the control of actuating cylinders 4 and 5 and coupling cylinder 31, is combined with an electrical control system III into an additional component II,III.

Pressure supply system 43, 44, 42, 45, 46 consists of a pump 43, a motor 44 serving to drive pump 43, a pressure reservoir 42 for a hydraulic medium under pressure, a tank 46 for the hydraulic medium, and a pressure regulation valve 45. Pump 43 and reservoir 42 serve as a pressure medium source. Hydraulic medium tank 46 also functions as a pressure medium sink.

Controllable valve system 22, 23, 24, 25, 26, 27, 28, 29 includes a first housing element 2, in which a first solenoid valve 22, in the form of a 3/2-way valve, a second solenoid valve 23, in the form of a 3/2-way valve, and a third solenoid valve 26, in the form of a 2/2-way valve, are located. A pressure medium input of third solenoid valve 26 is connected via a pressure medium channel to pressure medium source 43, 42, and a pressure medium output of third solenoid valve 26 is connected via pressure medium channels to a pressure medium output of first solenoid valve 22, and to a pressure medium input of second solenoid valve 23. A pressure medium output of first solenoid valve 22 is connected via a pressure medium channel to a first pressure medium connection 21 of first housing element 2, and a pressure medium output of second solenoid valve 23 is connected via another pressure medium channel to a second pressure medium connection 18 of first housing element 2. First pressure medium connection 21 of first housing element 2 is connected via a pressure medium channel 20 to the first pressure medium connection 10 of actuating cylinder unit I, and the second pressure medium connection 18 of first housing element 2 is connected via a pressure medium channel 19 to the second pressure medium connection 11 of actuating cylinder unit I. A pressure medium outlet of first solenoid valve 22, and a pressure medium outlet of second solenoid valve 23, are connected via pressure medium channels to tank 46.

Either first pressure medium chamber 9 or second pressure medium chamber 8, of first actuating cylinder 4, can be selectively connected to pressure medium source 43, 42, or to tank 46, or can be closed off against both by means of the three solenoid valves 22, 23, 24.

A fourth solenoid valve 24, a fifth solenoid valve 25, a sixth solenoid valve 27, a seventh solenoid valve 28, and an eighth solenoid valve 29, are installed in first housing element 2. A pressure medium input of fourth solenoid valve 24, in the form of a 3/2-way valve, and a pressure medium input of fifth solenoid valve 25, in the form of a 3/2-way valve, are connected via pressure medium channels to pressure medium source 43, 42, and a pressure medium outlet of fourth solenoid valve 24, as well as a pressure medium outlet of fifth solenoid valve 25, are connected via pressure medium channels to tank 46. A pressure medium output of fourth solenoid valve 24 is connected via a pressure medium channel to a third pressure medium connection 17 of first housing element 2, and a pressure medium output of fifth solenoid valve 25 is connected via a pressure medium channel to a fourth pressure medium connection 14 of first housing element 2. Third pressure medium connection 17 of first housing element 2 is connected via a pressure medium channel 16 to third pressure medium connection 12 of actuating cylinder unit I, and fourth pressure medium connection 14 of first housing element 2 is connected via a pressure medium channel 15 to fourth pressure medium connection 13 of actuating cylinder unit I.

Either first pressure medium chamber 6, or second pressure medium chamber 7, of second actuating cylinder 5, can be selectively connected to pressure medium source 43, 42, or to tank 46, by means of fourth solenoid valve 24 and fifth solenoid valve 25.

The pressure medium input of sixth solenoid valve 27, in the form of a 2/2-way valve, is connected via a pressure medium channel to pressure medium source 43, 42, and the pressure medium output of sixth solenoid valve 27 is connected via a pressure medium channel to a fifth pressure medium connection 50, within first housing element 2 of controllable valve system 22, 23, 24, 25, 26, 27, 28, 29, and serves to introduce the pressure medium into coupling cylinder 31.

A pressure medium input of seventh solenoid valve 28, in the form of a 2/2-way valve in controllable valve system 22, 23, 24, 25, 26, 27, 28, 29, is connected via a pressure medium channel to fifth pressure medium connection 50, and an output of seventh solenoid valve 28 is connected via a pressure medium channel to tank 46. Eighth solenoid valve 29, in the form of a 2/2-way valve, has its pressure medium input connected via a pressure medium channel to fifth pressure medium connection 50 within first housing element 2, while the pressure medium output of eighth solenoid valve 29 is connected via a pressure medium channel to tank 46. Fifth pressure medium connection 50, of first housing element 2, is connected via a pressure medium channel 30 to coupling cylinder 31.

As such, seventh solenoid valve 28 and eighth solenoid valve 29 serve to connect coupling cylinder 31 to tank 46.

The solenoid valves of controllable valve system 22, 23, 24, 25, 26, 27, 28, 29 are connected electrically, via electrical cables 32, 33, 34, 35, 36, 37, 38, 40, to an electrical control system III. Motor 44, which drives pump 43, is connected via electrical cable 39 to electrical control system III. In the same manner, distance sensors 48, 49, assigned to actuating cylinders 4, 5, as well as a pressure sensor 47, are electrically connected to electrical control system III, via electrical cables which are not shown in FIG. 1. Pressure sensor 47 is located in the pressure medium channel which connects the pressure medium output of third solenoid valve 26 to the pressure medium input of first solenoid valve 22, and also to the pressure medium input of second solenoid valve 23.

Electrical control system III is provided with at least one support 41 for electrical and electronic components, and is located within the second housing element 3. Support 41 can be implemented, illustratively, by a printed circuit board, on which electrical and electronic devices are located, for the evaluation of signals emitted by distance sensors 48, 49 and pressure sensor 47, and for the generation of control signals. These control signals, which depend on signals from distance sensors 48, 49 and pressure sensor 47, as well as on signals from a gear selection system which is not shown, serve to control valve system 22, 23, 24, 25, 26, 27, 28, 29.

Second housing element 3, of electrical control system III, is connected mechanically to first housing element 2 by means of connecting devices, such as screws, clamps, catch or snap connections. First housing element 2 contains controllable valve system 22, 23, 24, 25, 26, 27, 28, 29, pressure sensor 47 and, if applicable, the pressure regulating valve 45. Second housing element 3, when coupled together with first housing element 2, constitutes a housing 2,3, which includes controllable valve system 22, 23, 24, 25, 26, 27, 28, 29, pressure sensor 47, pressure regulating valve 45, and electrical control system III. The electrical connections between the electrical and electronic components installed on support 41 and their associated electrical cables, and, if applicable, with the electrical contacts of solenoid valves 22, 23, 24, 25, 26, 27, 28, 29 and pressure sensor 47, are preferably implemented by means of electrical plug-in devices, such as plug-in pins and sockets.

In this embodiment example, the pressure medium unit (hydraulic unit II), which contains controllable valve system 22, 23, 24, 25, 26, 27, 28, 29 and at least part of pressure supply system 44, 43, 42, 45, 46, together with electrical control system III, constitute the integrated component II,III. As a minimum, the combination of pump 43 and motor 44, for example, is understood to be part of pressure supply system 44, 43, 42, 45, 46.

Alternately, in accordance with the present invention, it is also possible to install tank 46 and/or reservoir 42 and/or pressure regulation valve 45 outside of housing 2,3, at a suitable location in proximity to the component II,III.

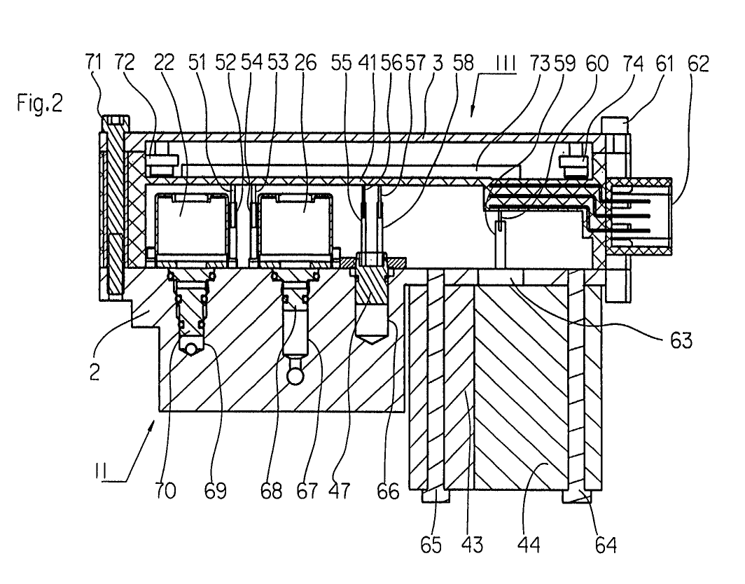

FIG. 2 shows first housing element 2 and second housing element 3, where second housing element 3 serves as a cover for first housing element 2. The two housing elements together form a housing 2,3 of controllable valve system 22, 23, 24, 25, 26, 27, 28, 29 and electrical control system III. The two housing elements 2 and 3 are connected to each other by means of fasteners 61, 71, e.g., in the form of screws. A stepped bore 69 is located in first housing element 2 to receive a valve insert 70 for first solenoid valve 22, and an additional stepped bore 67 is located in first housing element 2 to receive a valve insert 68 for third solenoid valve 26. The receiving bores and inserts of the other solenoid valves 23, 24, 25, 27, 28, 29 shown in FIG. 1 are not shown in FIG. 2, for simplicity. The inputs and outputs of solenoid valves 22, 26, formed by inserts 70 and 68, are connected by housing channels, which are not shown, but which serve as pressure medium channels to their assigned pressure medium connections of first housing element 2, and, in part, also to each other, as shown in FIG. 1. An additional stepped bore 66 in first housing element 2 serves to receive pressure sensor 47.

Referring again to FIG. 2, solenoid valves 22, 26 are positioned with one side on their assigned valve seats 70, 68, on the floor of first housing element 2, and extend with their other side in the direction of second housing element 3. An electrical connection via plug-in socket 52 is located on the solenoid of first solenoid valve 22. In the same manner, the solenoid of third solenoid valve 26 has an electrical plug-in connection via socket 54, and pressure sensor 47 has electrical connections via sockets 55 and 58, which also extend in the direction of second housing element 3. Similarly, the solenoids of the other solenoid valves 23, 24, 25, 27, 28, 29, which are not shown in FIG. 2, are provided with electric connections comprising plug-in sockets, which also extend in the direction of second housing element 3.

On the side of second housing element 3 which faces first housing element 2, a support 41, made of an insulating material such as plastic, contains electrical and electronic components 73 of electrical control system III, and is attached by means of fasteners 72, 74, which may be in the form of screws. Support 41 can be made in the form of a printed circuit. Plug-in pins 51, 53, 56, 57 connected to the electrical and electronic components are placed on support 41 so that they extend in the direction of plug-in sockets 52, 54, 55, 58, and constitute an electrical plug-in connection with their assigned plug-in sockets 52, 54, 55, 58, when the two housing elements 2,3 have been joined together. Additional plug-in pins connected to the electrical and electronic components of electrical control system III are provided, and pass through the lateral wall of second housing element 3 to form an electrical connection plug 62 for electrical control system III, together with a plug-in socket installed in the lateral wall of second housing element 3.

First housing element 2 has a step on its side away from second housing element 3. Pump 43 and motor 44 follow the contour of the stepped area of first housing element 2, and are connected by means of fasteners 64, 65, such as screws, to first housing element 2. Motor 44 has an electrical connection 63, 59, which extends through an opening in first housing element 2 into housing 2,3. Plug-in socket 59 of the electrical connection 63,59 extends in the direction of its assigned plug-in pins 60, located on support 41, of which only one is shown in the drawing, and, together with plug-in pins 60, forms an electrical plug-in connection.

Thus, controllable valve system 22, 23, 24, 25, 26, 27, 28, 29, located in first housing element 2, together with pump 43 and motor 44 attached to first housing element 2, plus electrical control system III, located in second housing element 3, constitute the integrated component II,III.

The electrical and electronic components and the electrical connections of electrical control system III, as well as valve system 22, 23, 24, 25, 26, 27, 28, 29, pressure sensor 47, and motor 44, are all within a protected environment, since they are within the space delineated by first housing element 2 and second housing element 3.

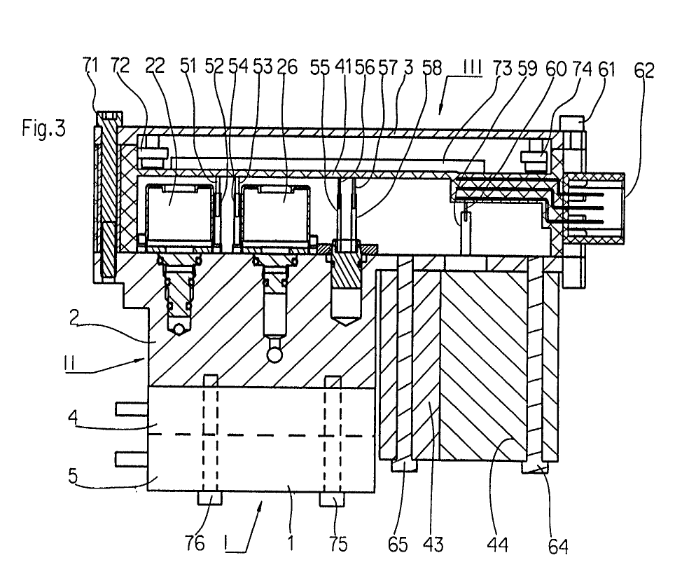

FIG. 3 shows a second embodiment of the present invention, wherein the actuating cylinder unit I, consisting of the two actuating cylinders 4,5, is also installed on, and combined with the component II,III.

Since the hydraulic unit II and the electrical control system III in this embodiment have the same structure, and are also connected to each other in the same manner as in the previous embodiment of FIG. 2, this embodiment shall be described hereinafter only to the extent necessary.

Referring again to FIG. 3, on the side of first housing element 2 away from second housing element 3, pump 43 and motor 44 are attached by means of screws 64,65. On the same side of first housing element 2, actuating cylinder unit I is also connected to first housing element 2, and thereby to housing 2, 3, by means of connecting screws 75,76. The pressure medium connections of actuating cylinders 4, 5 are connected via pressure medium channels (not shown), which can consist of housing channels in first housing element 2, to their associated pressure medium outputs of the controllable valve system.

Thus, the combination of hydraulic unit II, constituted by controllable valve system 22, 23, 24, 25, 26, 27, 28, 29 and pressure supply system 43, 44, 42, 45, 46, together with actuating cylinder unit I, constituted by actuating cylinders 4, 5, and together with electrical control system III, constitute a fully integrated component II,I,III.

Alternately, in accordance with the present invention, it is possible to mount actuating cylinders 4, 5 separately on the transmission, or separately on housing 2,3.

In addition, pump 43, motor 44, tank 46, pressure regulation valve 45, and, if applicable, reservoir 42, which together constitute the pressure supply system, can be installed either in entirety or in part on housing 2,3.

Furthermore, controllable valve system 22, 23, 24, 25, 26, 27, 28, 29 and, if applicable, part of pressure supply system 43, 44, 42, 45, 46 can be installed in first housing element 2, while electrical system 73, with support 41, can be installed in second housing element 3, where together the two housing elements constitute housing 2,3 of the component II,III, or of the component II,III,4,5, which consists of the hydraulic unit II, the electrical control system III, and, if applicable, the actuating cylinders 4,5.

Still another configuration, in accordance with the present invention, would install controllable valve system 22, 23, 24, 25, 26, 27, 28, 29 and, if applicable, part of pressure supply system 43, 44, 42, 45, 46 in a first closed housing, while electrical system 73, with support 41, would be installed in a second closed housing. These two housings would then be connected to each other by connecting devices, such as screws. Both housings would have openings, through which electrical connections would pass, serving to connect the devices contained in the first closed housing, such as solenoids of the solenoid valves, or the pressure sensor, to electrical system 73, with support 41, located in the second closed housing. These two housings, when connected to each other, then constitute the housing of component II,III or II,III,4,5, which would consist of hydraulic unit II, electrical control system III and, if applicable, actuating cylinders 4,5.

Also, in the present invention, compressed air can be used as the pressure medium. In this case, the pressure supply system would consist of a compressor, a compressed-air reservoir, and a pressure regulation valve.

In short, a compact, integrated, transmission control system is disclosed which provides the advantages of enhanced reliability and universal adaptability.

The above described embodiments of the invention are intended to be illustrative only. Numerous alternative embodiments may be devised by those skilled in the art without departing from the spirit and scope of the following claims.

1. A control system component for a transmission, comprising:
a. a pressure supply system,
b. an actuating cylinder unit,
c. a controllable valve system, having a plurality of electrically controlled solenoid valves, which connects the actuating cylinder unit to the pressure supply system,
d. an electrical control system, having a plurality of electrical devices, which actuates the controllable valve system,
wherein the controllable valve system, at least part of the pressure supply system, and the electrical control system are all mechanically and electrically combined into a single control system component.

2. The control system component of claim 1 wherein the pressure supply system includes a compressor and a compressed-air reservoir.

3. The control system component of claim 1 wherein the pressure supply system includes a pump, a motor to drive the pump, a tank to hold a hydraulic medium and, optionally, a reservoir for containing the hydraulic medium under pressure.

4. The control system component of claim 3 wherein:
a. the component having the controllable valve system, at least part of the pressure supply system and the electrical control system, includes a housing unit which comprises a first housing element and a second housing element, wherein the first and second housing elements are directly connected to each other,
b. the controllable valve system is located in the first housing element, and the electrical control system is located in the second housing element, and
c. at least the pump and the motor of the pressure supply system are located on and connected directly to the housing unit.

5. The control system component of claim 3 wherein:
a. the component having the controllable valve system, at least part of the pressure supply system and the electrical control system, includes a housing unit which comprises a first housing element and a second housing element, wherein the first and second housing elements are directly connected to each other,
b. the controllable valve system is located in the first housing element, and the electrical control system is located in the second housing element,
c. at least the pump and the motor of the pressure supply system are installed on at least one of the housing elements, and are directly connected thereto, and
d. each of the two housing elements has openings through which electrical connecting means are passed, serving to connect the electrical devices in the first housing element to the electrically controlled solenoid valves in the second housing element.

6. The control system component of claim 5 wherein the tank is located within the housing unit of the component, or on the outside of the housing unit of the component, in such manner that it is part of the component.

7. The control system component of claim 5 wherein the reservoir is located within the housing unit of the component, or on the outside of the housing unit of the component, in such manner that it is part of the component.

8. The control system component of claim 5 wherein the electrical connecting means of the electrically controlled solenoid valves of the controllable valve system, of any electric components of at least one part of the pressure supply system, and of the electrical devices of the electrical control system, are located in a space delimited by the two housing elements, or by the housing unit.

9. A control system component for a transmission, comprising:
a. a pressure supply system,
b. an actuating cylinder unit,
c. a controllable valve system, having a plurality of electrically controlled solenoid valves, which connects the actuating cylinder unit to the pressure supply system,
d. an electrical control system, having a plurality of electrical devices, which actuates the controllable valve system,
wherein the controllable valve system, at least part of the pressure supply system, the electrical control system, and the actuating cylinder unit are all mechanically and electrically combined into a single control system component.
